(19) United States
(12) Patent Application Publication
(10) Pub. No.: US 2021/0318588 A1
(43) Pub. Date: Oct. 14, 2021

(54) OPTICAL MODULATOR

(71) Applicant: Fujitsu Optical Components Limited, Kawasaki-shi (JP)

(72) Inventors: Kazuyuki WAKABAYASHI, Kawasaki (JP); Tamotsu AKASHI, Atsugi (JP); Toshihiro OHTANI, Yokohama (JP)

(73) Assignee: Fujitsu Optical Components Limited, Kawasaki-shi (JP)

(21) Appl. No.: 17/158,445

(22) Filed: Jan. 26, 2021

(30) Foreign Application Priority Data
Apr. 8, 2020 (JP) 2020-070098

(51) Int. Cl. G02F 1/225; G02F 1/03

(52) U.S. Cl. CPC G02F 1/225; G02F 1/212; G02F 1/0316

(57) ABSTRACT

An optical modulator includes an optical waveguide, a first slab and a second slab. The optical waveguide is formed by filling polymer in a slot portion formed between a first rail and a second rail disposed in parallel to the first rail. The first slab includes a first partial slab electrically connected to a first electrode and a second partial slab that electrically connects the first rail and the first partial slab. In the first slab, a thickness dimension of the second partial slab is set small compared with that of the first rail. The second slab includes a third partial slab electrically connected to a second electrode and a fourth partial slab that electrically connects the second rail and the third partial slab. In the second slab, a thickness dimension of the fourth partial slab is set small compared with that of the second rail.

### CROSS-REFERENCE TO RELATED APPLICATION

This application is based upon and claims the benefit of priority of the prior Japanese Patent Application No. 2020-070098, filed on Apr. 8, 2020, the entire contents of which are incorporated herein by reference.

### FIELD

The embodiments discussed herein are related to an optical modulator.

### BACKGROUND

LiNbO₃ (lithium niobate) has been known as an electro-optic material used in an optical modulator. However, in recent years, an electro-optic material adaptable to large-capacity high-speed optical communication performance has been demanded. Therefore, as a new electro-optic material replacing LiNbO₃, for example, an electro-optic type organic material such as EO polymer has been known.

The EO polymer has a higher electro-optic effect and wideband property than LiNbO₃. Therefore, the EO polymer has been expected as a prospective candidate of an electro-optic material for ultrahigh-speed optical communication at 64 Gbaud or more.
[Patent Document 1] International Publication Pamphlet No. WO 2016/092829
[Patent Document 2] Japanese Laid-open Patent Publication No. 2007-25370

However, in the EO polymer, a refractive index of light is as low as approximately 1.6 to 1.8. Therefore, in a normal optical waveguide structure, the EO polymer is not suitable for concentrating the light. A leak of the light occurs in the optical waveguide structure. As a result, because of the leak of the light of the optical waveguide structure, not only an optical loss but also a driving voltage in phase-modulating an optical signal increases.

### SUMMARY

According to an aspect of an embodiment, an optical modulator includes a slot portion, an optical waveguide, a first slab and a second slab. The slot portion is formed between a first rail disposed on a substrate and a second rail disposed on the substrate in parallel to the first rail. The optical waveguide is formed by filling an electro-optic material in the slot portion. The first slab electrically connects the first rail and a first electrode and is disposed on the substrate. The second slab electrically connects the second rail and a second electrode and is disposed on the substrate. The first slab includes a first partial slab electrically connected to the first electrode and a second partial slab electrically connecting the first rail and the first partial slab. A thickness dimension of the second partial slab with respect to a surface of the substrate is set small compared with the thickness dimension of the first rail. The second slab includes a third partial slab electrically connected to the second electrode and a fourth partial slab electrically connecting the second rail and the third partial slab. A thickness dimension of the fourth partial slab with respect to the surface of the substrate is set small compared with the thickness dimension of the second rail.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a plan view illustrating an example of an optical modulator in a first embodiment;

FIG. 2 is an A-A line sectional view of FIG. 1;

FIG. 3 is a perspective view of a slab in the first embodiment;

FIG. 4A is an explanatory diagram illustrating an example of a manufacturing process for the optical modulator;

FIG. 4B is an explanatory diagram illustrating the example of the manufacturing process for the optical modulator;

FIG. 4C is an explanatory diagram illustrating the example of the manufacturing process for the optical modulator;

FIG. 5A is an explanatory diagram illustrating the example of the manufacturing process for the optical modulator;

FIG. 5B is an explanatory diagram illustrating the example of the manufacturing process for the optical modulator;

FIG. 5C is an explanatory diagram illustrating the example of the manufacturing process for the optical modulator;

FIG. 6 is an explanatory diagram illustrating an example of an action during polling of the optical modulator;

FIG. 7 is an explanatory diagram illustrating an example of an action during operation of the optical modulator;

FIG. 8 is an explanatory diagram illustrating an example of an equivalent circuit of the optical modulator illustrated in FIG. 7;

FIG. 9 is an explanatory diagram illustrating an example of dimensions of the optical modulator;

FIG. 10 is an explanatory diagram illustrating an example of an optical mode analysis result of the optical modulator;

FIG. 11 is an explanatory diagram illustrating an example of dimensions of an optical modulator in a comparative example 1;

FIG. 12 is an explanatory diagram illustrating an example of an optical mode analysis result of the optical modulator in the comparative example 1;

FIG. 13 is an explanatory diagram illustrating an example of dimensions of an optical modulator in a comparative example 2;

FIG. 14 is an explanatory diagram illustrating an example of an optical mode analysis result of the optical modulator in the comparative example 2;

FIG. 15 is an explanatory diagram illustrating an example of a comparison result of a half wavelength voltage Vπ, an optical loss, and a wideband property of each of the optical modulator in the first embodiment, the optical modulator in the comparative example 1, and the optical modulator in the comparative example 2;

FIG. 16 is an A-A line sectional view of an optical modulator in a second embodiment;

FIG. 17 is a perspective view of a slab in the second embodiment;

FIG. 18 is a plan view illustrating an example of an optical modulator (a GSG type) in a third embodiment;

FIG. 19 is an A1-A1 line sectional view of FIG. 18;

FIG. 20 is a perspective view of a slab in the third embodiment;

FIG. 21 is an explanatory diagram illustrating an example of an action during polling of the optical modulator;

FIG. 22 is an explanatory diagram illustrating an example of an action during operation of the optical modulator;

FIG. 23 is a plan view illustrating an example of an optical modulator (a GSSG type) in a fourth embodiment;

FIG. 24 is an A2-A2 line sectional view of FIG. 23;

FIG. 25 is a perspective view of a slab in the fourth embodiment;

FIG. 26 is an explanatory diagram illustrating an example of an action during polling of the optical modulator;

FIG. 27 is an explanatory diagram illustrating an example of an action during operation of the optical modulator;

FIG. 28 is a plan view illustrating an example of an optical modulator (a GSGSG type) in a fifth embodiment;

FIG. 29 is an A3-A3 line sectional view of FIG. 28;

FIG. 30 is a perspective view of a slab in the fifth embodiment;

FIG. 31 is an explanatory diagram illustrating an example of an action during polling of the optical modulator; and

FIG. 32 is an explanatory diagram illustrating an example of an action during operation of the optical modulator.

### DESCRIPTION OF EMBODIMENTS

Preferred embodiments of the present invention will be explained with reference to accompanying drawings. Note that the disclosed technology is not limited by the embodiments. The embodiments explained below may be combined as appropriate in a range in which the embodiments do not cause contradiction.

### [a] First Embodiment

Configuration of Optical Modulator 1

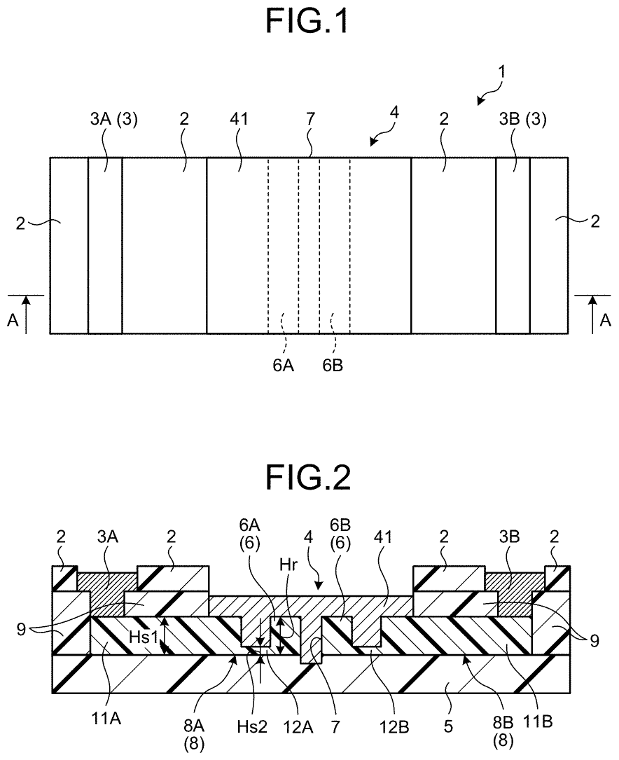

FIG. 1 is a plan view illustrating an example of an optical modulator 1 in a first embodiment. The optical modulator 1 illustrated in FIG. 1 is, for example, a slot-type phase modulator. The optical modulator 1 includes a first protective film 2, a first electrode 3A (3), a second electrode 3B (3), and an optical waveguide 4. The first electrode 3A is, for example, a positive electrode that applies a driving voltage of an electric signal or the like. The second electrode 3B is, for example, a negative electrode. The optical waveguide 4 is a waveguide that is formed of, for example, EO polymer 41 such as an electro-optic material and in which an optical signal passes.

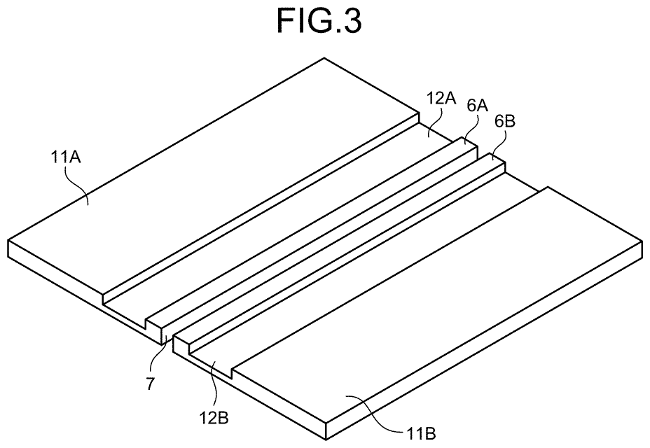

FIG. 2 is an A-A line sectional view of FIG. 1. FIG. 3 is a perspective view of a first slab 8A, a first rail 6A, the optical waveguide 4, a second rail 6B, and a second slab 8B in the first embodiment. The optical modulator 1 illustrated in FIG. 2 includes, besides the first protective film 2, the first electrode 3A, the second electrode 3B, and the optical waveguide 4, a substrate 5, the first rail 6A (6), the second rail 6B (6), and a slot portion 7. Further, the optical modulator 1 includes the first slab 8A (8), the second slab 8B (8), a second protective film 9, and an electrode pad 2A (2B).

The substrate 5 is, for example, a substrate of SiO₂. The first rail 6A and the second rail 6B are formed of, for example, a high-refractive index material such as silicon. The first rail 6A and the second rail 6B are disposed in parallel on the substrate 5. The slot portion 7 is a space serving as a low refraction region formed between the first rail 6A and the second rail 6B disposed in parallel on the substrate 5. The optical waveguide 4 is formed by filling the EO polymer 41 in the slot portion 7. The optical waveguide 4 is structure for confining light passing through the optical waveguide 4.

The first slab 8A is disposed on the substrate 5 and electrically connects the first rail 6A and the first electrode 3A. The first slab 8A is formed of, for example, silicon. The second slab 8B is disposed on the substrate 5 and electrically connects the second rail 6B and the second electrode 3B. The second slab 8B is also formed of, for example, silicon.

The first slab 8A includes a first partial slab 11A and a second partial slab 12A. The first partial slab 11A is electrically connected to the first electrode 3A. The second partial slab 12A electrically connects the first rail 6A and the first partial slab 11A. In the first slab 8A, a thickness dimension Hs2 of the second partial slab 12A is set small compared with a thickness dimension Hr of the first rail 6A with respect to the surface of the substrate 5. Note that it is desirable to set the thickness dimension Hr of the first rail 6A to a triple or more of the thickness dimension Hs2 of the second partial slab 12A. The thickness dimension Hr of the first rail 6A and a thickness dimension Hs1 of the first partial slab 11A are, for example, the same.

The second slab 8B includes a third partial slab 11B and a fourth partial slab 12B. The third partial slab 11B is electrically connected to the second electrode 3B. The fourth partial slab 12B electrically connects the second rail 6B and the third partial slab 11B. In the second slab 8B, the thickness dimension Hs2 of the fourth partial slab 12B is set small compared with the thickness dimension Hr of the second rail 6B with respect to the surface of the substrate 5. Note that it is desirable to set the thickness dimension Hr of the second rail 6B to a triple or more of the thickness dimension Hs2 of the fourth partial slab 12B. The thickness dimension Hr of the second rail 6B and the thickness dimension Hs1 of the third partial slab 11B are, for example, the same.

Manufacturing Process for Optical Modulator 1

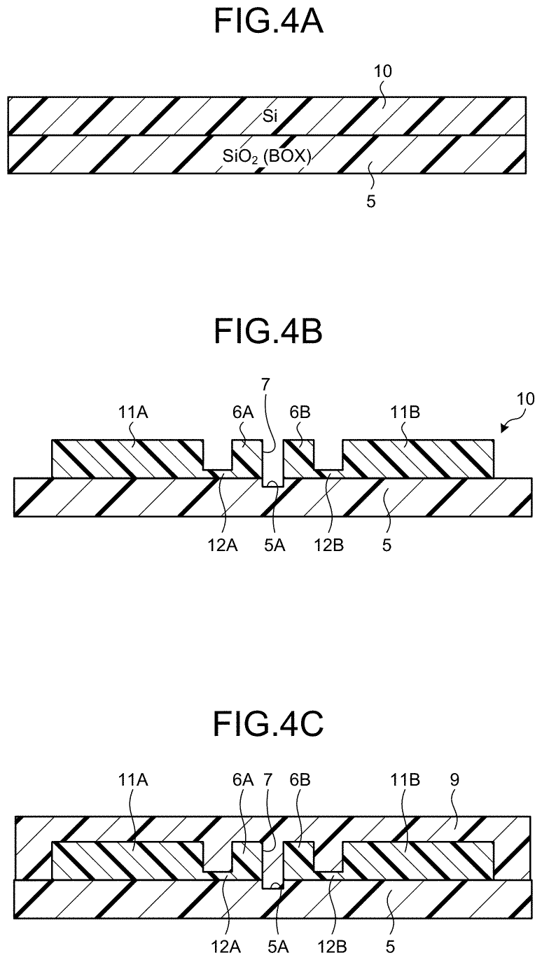

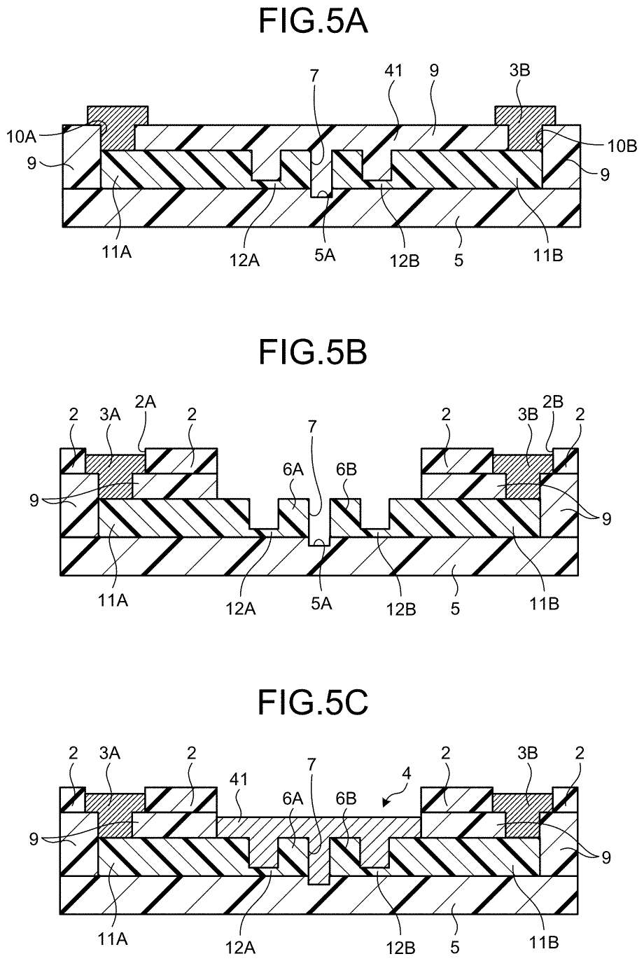

FIGS. 4A to 4C are explanatory diagrams illustrating an example of a manufacturing process for the optical modulator 1. FIGS. 5A to 5C are explanatory diagrams illustrating the example of the manufacturing process for the optical modulator 1. Silicon 10, which is the material of the first slab 8A, the first rail 6A, the second rail 6B, and the second slab 8B, is disposed on the substrate 5 illustrated in FIG. 4A.

For example, the first rail 6A, the second rail 6B, the first slab 8A, and the second slab 8B are formed on the substrate 5 by etching the silicon 10 on the substrate 5 illustrated in FIG. 4B. A recess 5A is formed on the surface of the substrate 5 equivalent to a part where the slot portion 7 formed between the first rail 6A and the second rail 6B is formed. Note that the recess 5A may be present in order to surely fill the EO polymer 41 explained below in the slot portion 7. As a result, a thickness dimension of the first rail 6A, the first partial slab 11A, the second rail 6B, and the third partial slab 11B illustrated in FIG. 4B is set to, for example, a triple or more of a thickness dimension of the second partial slab 12A. The thickness dimension Hs2 of the second partial slab 12A and the thickness dimension Hs2 of the fourth partial slab 12B are the same.

The second protective film 9 of, for example, SiO₂ is formed on the first rail 6A, the second rail 6B, the first slab 8A, and the second slab 8B formed on the substrate 5 illustrated in FIG. 4C.

Further, parts of the second protective film 9 on the first slab 8A and the second slab 8B are etched to form a first opening 10A on the first slab 8A and a second opening 10B on the second slab 8B. As illustrated in FIG. 5A, the first electrode 3A electrically connected to the first slab 8A is formed on the first opening 10A and the second electrode 3B electrically connected to the second slab 8B is formed on the second opening 10B.

Further, the first protective film 2 of, for example, SiO₂ is formed on the first electrode 3A, the second electrode 3B, and the second protective film 9 illustrated in FIG. 5A. As illustrated in FIG. 5B, the first protective film 2 and the second protective film 9 on the first electrode 3A, the second electrode 3B, the first slab 8A, the second slab 8B, the slot portion 7, the first rail 6A, and the second rail 6B are etched. As a result, a first electrode pad 2A on the first electrode 3A and a second electrode pad 2B on the second electrode 3B are formed and the first slab 8A, the second slab 8B, and the slot portion 7 are exposed.

The EO polymer 41 is filled in the slot portion 7 illustrated in FIG. 5B to form the optical waveguide 4. Note that the optical waveguide 4 can be formed by filling the EO polymer 41 in the slot portion 7. The width of the slot portion 7 is in nanometer order. Therefore, in order to surely fill the EO polymer 41 in the slot portion 7, the EO polymer 41 is filled on the first rail 6A, the second rail 6B, the first slab 8A, and the second slab 8B around the slot portion 7.

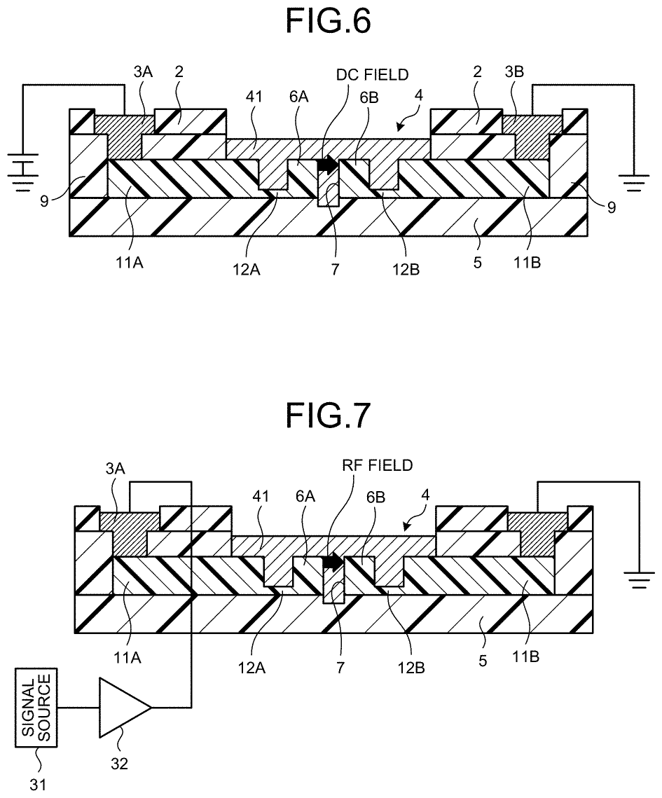

FIG. 6 is an explanatory diagram illustrating an example of an action during polling of the optical modulator 1. The optical modulator 1 formed through the manufacturing process illustrated in FIGS. 4 and 5 needs to execute polling processing in order to give the Pockels effect to the EO polymer 41 forming the optical waveguide 4 because the EO polymer 41 is amorphous and does not have an electro-optic effect. The EO polymer 41 in the optical waveguide 4 in the optical modulator 1 is heated to near the glass transition temperature to allow dye molecules in the EO polymer 41 to easily move. Then, a DC voltage is applied to the first electrode 3A. As a result, the DC voltage is applied to the first electrode 3A and an electric current flows from the first electrode 3A to the second electrode 3B. Therefore, the dye molecules of the EO polymer 41 in the optical waveguide 4 are oriented in one direction. Thereafter, the temperature of the EO polymer 41 in the optical waveguide 4 is lowered to fix a state of the orientation of the EO polymer 41.

Operation Action of Optical Modulator 1

FIG. 7 is an explanatory diagram illustrating an example of an action during operation of the optical modulator 1. The optical modulator 1 includes a signal source 31 that generates an electric signal and a driver 32 that outputs the electric signal (a driving voltage) received from the signal source 31. The driver 32 is connected to the first electrode 3A of the optical modulator 1 and connects the second electrode 3B to an earth. The driver 32 applies a driving voltage to the optical waveguide 4 in the optical modulator 1 and, when an electric current flows from the first electrode 3A to the second electrode 3B, phase-modulates an optical signal passing through the optical waveguide 4.

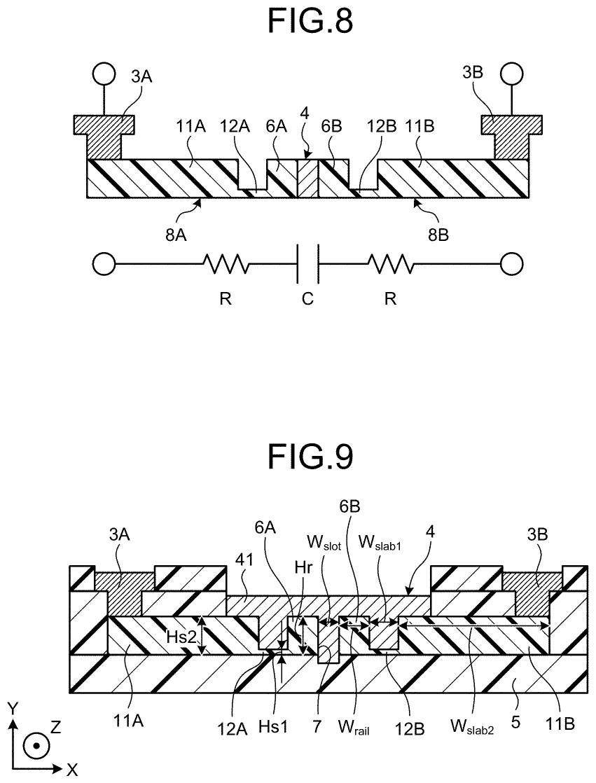

FIG. 8 is an explanatory diagram illustrating an example of an equivalent circuit of the optical modulator 1 illustrated in FIG. 7. The first electrode 3A, the first slab 8A, and the first rail 6A can be represented by an electric resistance R. The second rail 6B, the second slab 8B, and the second electrode 3B can also be represented by the electric resistance R. Further, the optical waveguide 4 can be represented by a capacitor C. Therefore, the first electrode 3A, the first slab 8A, the first rail 6A, the optical waveguide 4, the second rail 6B, the second slab 8B, and the second electrode 3B are equivalent to a low-pass filter illustrated in FIG. 8 having an RC constant. A cutoff frequency fc of the low-pass filter is calculated by ¼πRC. Therefore, when the electric resistance R increases, the cutoff frequency decreases and a band is limited.

FIG. 9 is an explanatory diagram illustrating an example of dimensions of the optical modulator 1. The thickness dimension Hs1 of the first partial slab 11A (the third partial slab 11B) on the surface of the substrate 5 illustrated in FIG. 9 is the thickness of the first partial slab 11A (the third partial slab 11B) in a Y direction in the figure. The thickness dimension Hs2 of the second partial slab 12A (the fourth partial slab 12B) on the surface of the substrate 5 is the thickness of the second partial slab 12A (the fourth partial slab 12B) in the Y direction in the figure. The thickness dimension Hr of the first rail 6A (the second rail 6B) on the surface of the substrate 5 is the thickness of the first rail 6A (the second rail 6B) in the Y direction in the figure.

Further, the thickness dimension Hs1 of the first partial slab 11A is the thickness of the first partial slab 11A between the surface of the second protective film 9 and the surface of the substrate 5. Thickness dimension Hs2 of the second partial slab 12A is the thickness of the second partial slab 12A between a contact surface of the EO polymer 41 and the surface of the substrate 5. The thickness dimension Hs1 of the fourth partial slab 12B is the thickness of the fourth partial slab 12B between the surface of the second protective film 9 and the surface of the substrate 5. The thickness dimension Hs2 of the third partial slab 11B is the thickness of the third partial slab 11B between the contact surface of the EO polymer 41 and the surface of the substrate 5.

Further, width Wslot of the optical waveguide 4 is the width of the slot portion 7 between the first rail 6A and the second rail 6B and is width of the optical waveguide 4 in an X direction in the figure. A rail width Wrail of the first rail 6A (the second rail 6B) is the width of the first rail 6A (the second rail 6B) in the X direction in the figure. Width Wslab1 of the first partial slab 11A (the third partial slab 11B) is the width of the first partial slab 11A (the third partial slab 11B) in the X direction in the figure. Width Wslab2 of the second partial slab 12A (the fourth partial slab 12B) is the width of the second partial slab 12A (the fourth partial slab 12B) in the X direction in the figure.

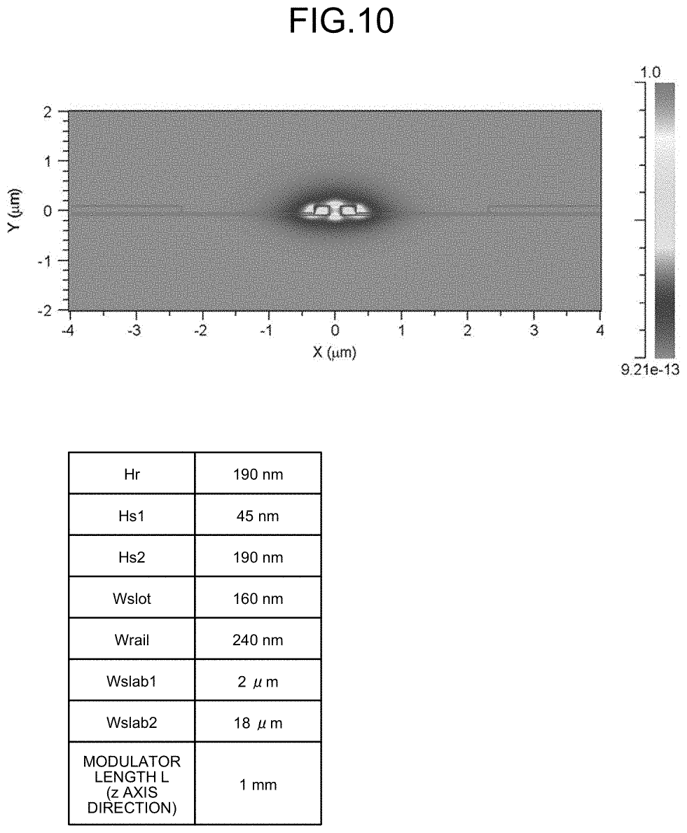

FIG. 10 is an explanatory diagram illustrating an example of an optical mode analysis result of the optical modulator 1. In the optical modulator 1 in the first embodiment, thickness Hs2 of the second partial slab 12A (the fourth partial slab 12B) is set to 45 nm and thickness Hs1 of the first partial slab 11A (the third partial slab 11B) is set to 190 nm. Further, in the optical modulator 1, thickness Hr of the first rail 6A (the second rail 6B) is set to 190 nm, and the width Wslot of the optical waveguide 4 is set to 160 nm, and the rail width Wrail of the first rail 6A (the second rail 6B) is set to 240 nm. Further, in the optical modulator 1, the width Wslab1 of the first partial slab 11A (the third partial slab 11B) is set to 18 μm, width Wslab2 of the second partial slab 12A (the fourth partial slab 12B) is set to 2 μm, and the length in a Z-axis direction of the optical modulator 1 is set to 1 mm. In this case, it is seen from an optical mode analysis result of the optical modulator 1 that an optical signal is confined in the optical waveguide 4 as illustrated in FIG. 10.

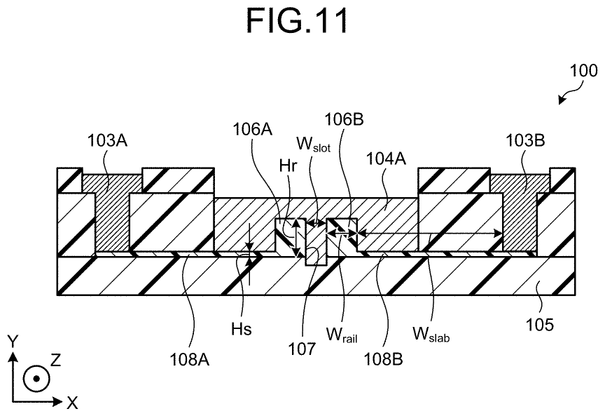

FIG. 11 is an explanatory diagram illustrating an example of dimensions of an optical modulator 100 in a comparative example 1. The optical modulator 100 in the comparative example 1 illustrated in FIG. 11 includes an eleventh slab 108A electrically connecting an eleventh rail 106A and an eleventh electrode 103A and a twelfth slab 108B electrically connecting a twelfth rail 106B and a twelfth electrode 103B. An optical waveguide 104 is formed by filling EO polymer 104A in a slot portion 107 between the eleventh rail 106A and the twelfth rail 106B. A thickness dimension Hs of the eleventh slab 108A (the twelfth slab 108B) is set small compared with the thickness dimension Hs1 of the first partial slab 11A (the third partial slab 11B) in the first embodiment.

The thickness dimension Hs of the eleventh slab 108A (the twelfth slab 108B) on the surface of a substrate 105 is the thickness of the eleventh slab 108A (the twelfth slab 108B) in the Y direction in the figure. The thickness dimension Hr of the eleventh rail 106A (the twelfth rail 106B) on the surface of the substrate 105 is the thickness of the eleventh rail 106A (the twelfth rail 106B) in the Y direction in the figure. Further, the thickness dimension Hs of the eleventh slab 108A (the twelfth slab 108B) is the thickness of the eleventh slab 108A (the twelfth slab 108B) between the surface of a second protective film and the surface of the substrate 105.

Further, the width Wslot of the optical waveguide 104 is a slot width between the eleventh rail 106A and the twelfth rail 106B and is the width of the optical waveguide 104 in the X direction in the figure. The rail width Wrail of the eleventh rail 106A (the twelfth rail 106B) is the width of the eleventh rail 106A (the twelfth rail 106B) in the X direction in the figure. Width Wslab of the eleventh slab 108A (the twelfth slab 108B) is the width of the eleventh slab 108A (the twelfth slab 108B) in the X direction in the figure.

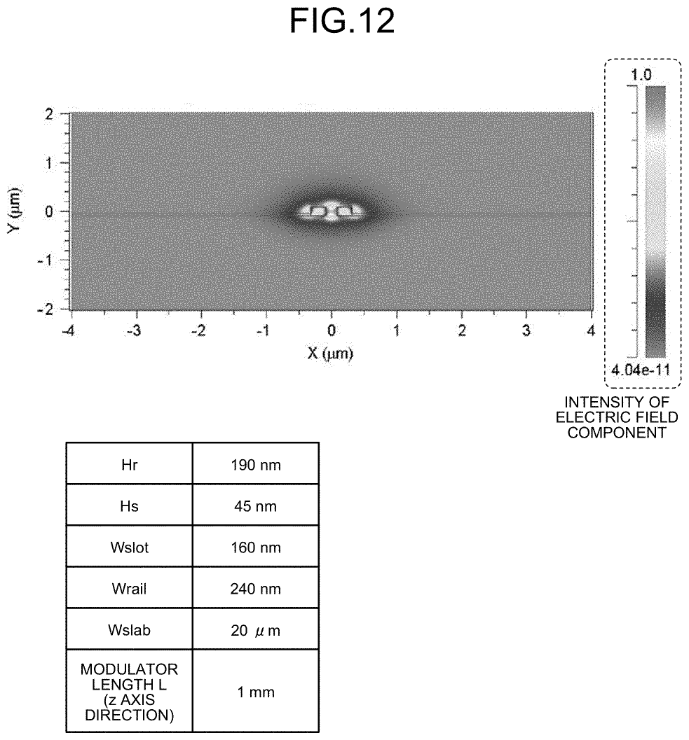

Optical modulator 100 in comparative example 1 FIG. 12 is an explanatory diagram illustrating an example of an optical mode analysis result of the optical modulator 100 in the comparative example 1. In the optical modulator 100 in the comparative example 1, thickness Hs of the eleventh slab 108A (the twelfth slab 108B) is set to 45 nm, thickness Hr of the eleventh rail 106A (the twelfth rail 106B) is set to 190 nm, and the width Wslot of the optical waveguide 104 is set to 160 nm. Further, in the optical modulator 100, the rail width Wrail of the eleventh rail 106A (the twelfth rail 106B) is set to 240 nm, the width Wslab of the eleventh slab 108A (the twelfth slab 108B) is set to 20 μm, and the length in the Z-axis direction of the optical modulator 100 is set to 1 mm. In this case, it is seen from an optical mode analysis result of the optical modulator 100 in the comparative example 1 that an optical signal is confined in the optical waveguide 104 as illustrated in FIG. 12.

Optical Modulator 100A in Comparative Example 2

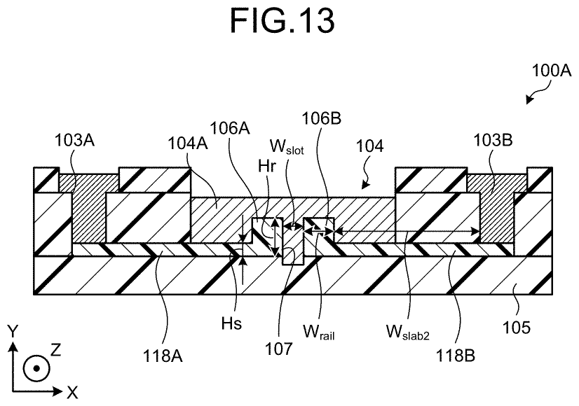

FIG. 13 is an explanatory diagram illustrating an example of dimensions of an optical modulator 100A in a comparative example 2. The optical modulator 100A in the comparative example 2 illustrated in FIG. 13 includes a twenty-first slab 118A electrically connecting the eleventh rail 106A and the eleventh electrode 103A and a twenty-second slab 118B electrically connecting the twelfth rail 106B and the twelfth electrode 103B. The thickness dimension Hs of the twenty-first slab 118A (the twenty-second slab 118B) is set large compared with the thickness dimension Hs of the eleventh slab 108A (the twelfth slab 108B) in the comparative example 1. Further, the thickness dimension Hs of the twenty-first slab 118A (the twenty-second slab 118B) is set large compared with the thickness dimension Hs1 of the first partial slab 11A (the third partial slab 11B) in the first embodiment.

The thickness dimension Hs of the twenty-first slab 118A (the twenty-second slab 118B) on the surface of the substrate 105 is the thickness of the twenty-first slab 118A (the twenty-second slab 118B) in the Y direction in the figure. The thickness dimension Hr of the eleventh rail 106A (the twelfth rail 106B) on the surface of the substrate 105 is the thickness of the eleventh rail 106A (the twelfth rail 106B) in the Y direction in the figure. Further, the thickness dimension Hs of the twenty-first slab 118A (the twenty-second slab 118B) is the thickness of the twenty-first slab 118A (the twenty-second slab 118B) between the surface of the second protective film and the surface of the substrate 105.

Further, the width Wslot of the optical waveguide 104 is a slot width of the slot portion 107 between the eleventh rail 106A and the twelfth rail 106B and is the width of the optical waveguide 104 in the X direction in the figure. The rail width Wrail of the eleventh rail 106A (the twelfth rail 106B) is the width of the eleventh rail 106A (the twelfth rail 106B) in the X direction in the figure. The width Wslab of the eleventh slab 108A (the twelfth slab 108B) is the width of the twenty-first slab 118A (the twenty-second slab 118B) in the X direction in the figure.

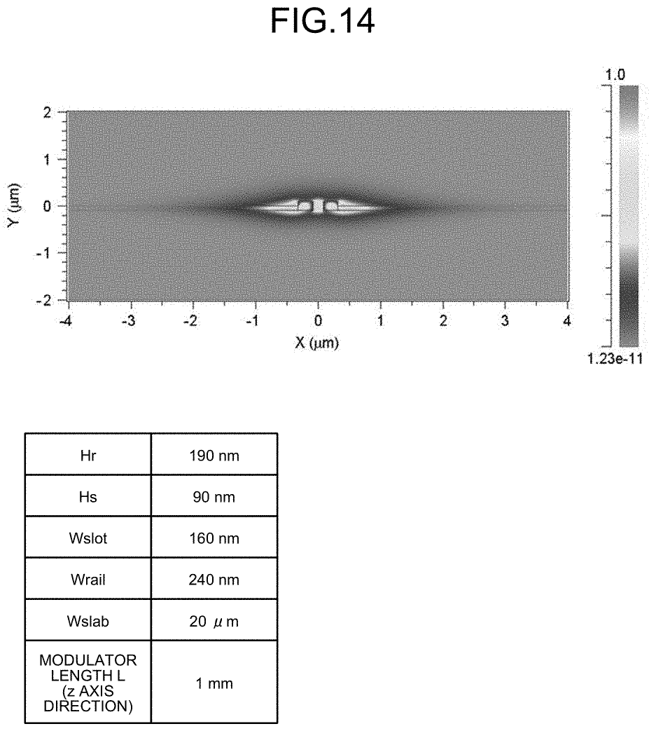

FIG. 14 is an explanatory diagram illustrating an example of an optical mode analysis result of the optical modulator 100A in the comparative example 2. In the optical modulator 100A in the comparative example 2, the thickness Hs of the twenty-first slab 118A (the twenty-second slab 118B) is set to 90 nm, the thickness Hr of the eleventh rail 106A (the twelfth rail 106B) is set to 190 nm, and the width Wslot of the optical waveguide 104 is set to 160 nm. In the optical modulator 100A, the rail width Wrail of the eleventh rail 106A (the twelfth rail 106B) is set to 240 nm, the width Wslab of the twenty-first slab 118A (the twenty-second slab 118B) is set to 20 μm, and the length in the Z-axis direction of the optical modulator 100A is set to 1 mm. In this case, it is seen from an optical mode analysis result of the optical modulator 100A in the comparative example 2 that an optical signal leaks from the optical waveguide 104 as illustrated in FIG. 14.

In the optical modulator 100 (100A) in the comparative example 1 and the comparative example 2, a trade-off occurs between a wideband property and a driving voltage/an optical loss. In order to use the optical waveguide 104 as an optical modulator, the slabs 108A (108B) (Si) electrically connecting the two rails 106A (106B) (Si) and the two electrodes 103A (103B) are needed. However, a part of light that may be confined in the slot portion 107 by the slabs (108A, 108B) leaks to the slab side. When there is such a leak of the light, efficiency is deteriorated and a large driving voltage is needed. Moreover, an optical loss at the time when the light passes through the optical waveguide 104 increases. Therefore, the half wavelength voltage Vπ, which is a driving voltage needed for changing a phase shift amount φ by π, can be represented by Vπ=(λd)/(n³γΓL).

Note that, a wavelength is represented as “λ”, the width of the slot portion 7 is represented as “d”, a refractive index of the electro-optic material (the EO polymer 41) is represented as “n”, an electro-optic constant of the electro-optic material (the EO polymer 41) is represented as “γ”, the length of the electrode 3 is represented as “L”, and an applied electric field reduction coefficient (a correction coefficient indicating a ratio of an electric field distribution contributing to modulation) is represented as “Γ”. “Γ” is an indicator indicating at which ratio an electric field is confined in the slot portion 7. When the leak of the light increases, “Γ” decreases. In this case, the half wavelength voltage Vπ increases. Therefore, it is needed to reduce the leak of the light to the slab 8 as much as possible in order to reduce the half wavelength voltage Vπ. In order to reduce the leak of the light, if the thickness dimension Hs of the slab 8 is set sufficiently small compared with the thickness dimension Hr of the first rail 6A (the second rail 6B), it is possible to suppress the leak of the light to the slab 8. However, the electric resistance R of the slab 8 increases. Further, when the electric resistance R increases, a cutoff frequency decreases and a band is limited.

Comparison Result

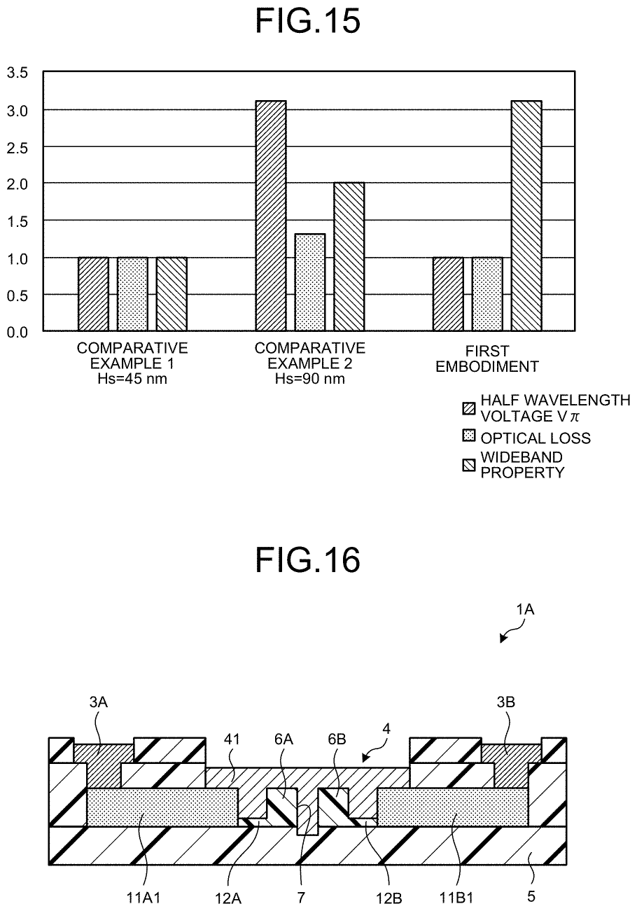

FIG. 15 is an explanatory diagram illustrating a comparison result of a driving voltage, an optical loss, and a wideband property in each of the optical modulator 1 in the first embodiment, the optical modulator 100 in the comparative example 1, and the optical modulator 100A in the comparative example 2. Note that, for convenience of explanation, in order to facilitate comparison, values of the half wavelength voltage Vπ, the optical loss, and the wideband property in the comparative example 1 are set to 1. It is more excellent that the values of the half wavelength voltage Vπ and the optical loss are smaller and it is more excellent that the value of the wideband property is larger.

In the optical modulator 100 in the comparative example 1, compared with the optical modulator 1 in the first embodiment, there are no marked differences in the half wavelength voltage Vπ and the optical loss. However, the electric resistance R increases because the thickness dimension of the slab 108A (108B) of the optical modulator 100 in the comparative example 1 is small. The cutoff frequency falls and the band is limited. Therefore, the optical modulator 1 in the first embodiment can set the band wide compared with the optical modulator 100 in the comparative example 1.

In the optical modulator 100A in the comparative example 2, since the leak of the light increases, the values of the half wavelength voltage Vπ and the optical loss increases. However, the electric resistance decreases as the thickness dimension of the slab increases. A wideband can be realized. In the optical modulator 100A in the comparative example 2, compared with the optical modulator 100 in the first embodiment, marked differences occur in the half wavelength voltage Vπ and the optical loss, the half wavelength voltage Vπ is large, the leak of the light is large, and the optical loss is large. Therefore, the optical modulator 1 in the first embodiment can reduce the wideband property, in particular, the half wavelength voltage Vπ and the optical loss compared with the optical modulator 100 in the comparative example 1.

In the comparative example 1 and the comparative example 2, trade-off by the half wavelength voltage Vπ/the optical loss and the wideband property occurs. In contrast, in the case of the optical modulator 1 in the first embodiment, although the half wavelength voltage Vπ/the optical loss are substantially equal to the half wavelength voltage Vπ/the optical loss in the comparative example 1, a wideband can be realized.

Effects in First Embodiment

In the optical modulator 1 in the first embodiment, a thickness dimension of the second partial slab 12A electrically connecting the first partial slab 11A electrically connected to the first electrode 3A and the first rail 6A is set small compared with the first rail 6A. Further, in the optical modulator 1, a thickness dimension of the fourth partial slab 12B electrically connecting the third partial slab 11B electrically connected to the second electrode 3B and the second rail 6B is set small compared with the second rail 6B. As a result, it is possible to reduce the half wavelength voltage Vπ and reduce the optical loss and it is possible to reduce the electric resistance R in a slab portion, suppress a decrease in the cutoff frequency, and realize the wideband.

Note that the thickness dimension of the second partial slab 12A (the fourth partial slab 12B) is reduced in an allowable range. The thickness dimension of the first partial slab 11A (the third partial slab 11B) is increased. As a result, since the thickness dimension of the second partial slab 12A (the fourth partial slab 12B) is small, it is possible to suppress the leak of the light during a modulating action.

Since the thickness dimension of the second partial slab 12A (the fourth partial slab 12B) decreases, when viewed in the thickness of the second partial slab 12A (the fourth partial slab 12B) alone, the electric resistance R increases. However, since the electric resistance R of the first partial slab 11A (the third partial slab 11B) can be reduced, when considered in the optical modulator 1 as a whole, the electric resistance R can be reduced compared with the comparative example 1 and the comparative example 2. As a result, it is possible to improve the trade-off that occurs between the wideband property and the driving voltage/the optical loss. A small, low-driving voltage, and wideband optical modulator mounted with the EO polymer 41 can be realized.

Note that, in the optical modulator 1 in the first embodiment, the thickness dimensions of the first partial slab 11A in the first slab 8A and the third partial slab 11B in the second slab 8B are the same as the thickness dimension of the first rail 6A (the second rail 6B). Therefore, the electric resistance R increases. Therefore, an embodiment for coping with such a situation is explained below as a second embodiment. Note that the same components as the components of the optical modulator 1 in the first embodiment are denoted by the same reference numerals and signs to omit redundant explanation about the components and actions.

### [b] Second Embodiment

Configuration of Optical Modulator 1A in Second Embodiment

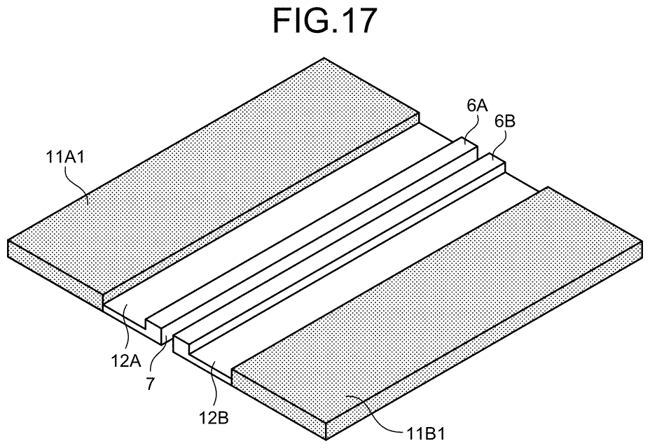

FIG. 16 is an A-A line sectional view of an optical modulator 1A in the second embodiment. FIG. 17 is a perspective view of the first slab 8A, the first rail 6A, the optical waveguide 4, the second rail 6B, and the second slab 8B in the second embodiment. The optical modulator 1A illustrated in FIG. 16 is different from the optical modulator 1 in the first embodiment in that doping concentration of silicon of a first partial slab 11A1 and a third partial slab 11B1 is set high. Note that the shape of the first partial slab 11A1 and the third partial slab 11B1 in the second embodiment is the same as the shape of the first partial slab 11A and the third partial slab 11B in the first embodiment.

Effects in Second Embodiment

In the optical modulator 1A in the second embodiment, the doping concentration of the silicon of the first partial slab 11A1 and the third partial slab 11B1 is set higher than the doping concentration of the first rail 6A and the second rail 6B and the second partial slab 12A and the fourth partial slab 12B. Therefore, it is possible to reduce the electric resistance of the first partial slab 11A1 and the third partial slab 11B1 and increase the cutoff frequency. Moreover, when the doping concentration is increased, the optical loss also increases. However, the optical modulator 1A is designed such that most of light can be converged in the slot portion 7, the second partial slab 12A, and the fourth partial slab 12B. As a result, it is possible to increase a band while neglecting the influence on the values of the half wavelength voltage Vπ and the optical loss.

Note that the optical waveguide 4 of the optical modulator 1 (1A) in the first and second embodiments can be considered, for example, one of two optical modulators in a Mach-Zehnder modulator.

### [c] Third Embodiment

Configuration of Optical Modulator 1B in Third Embodiment

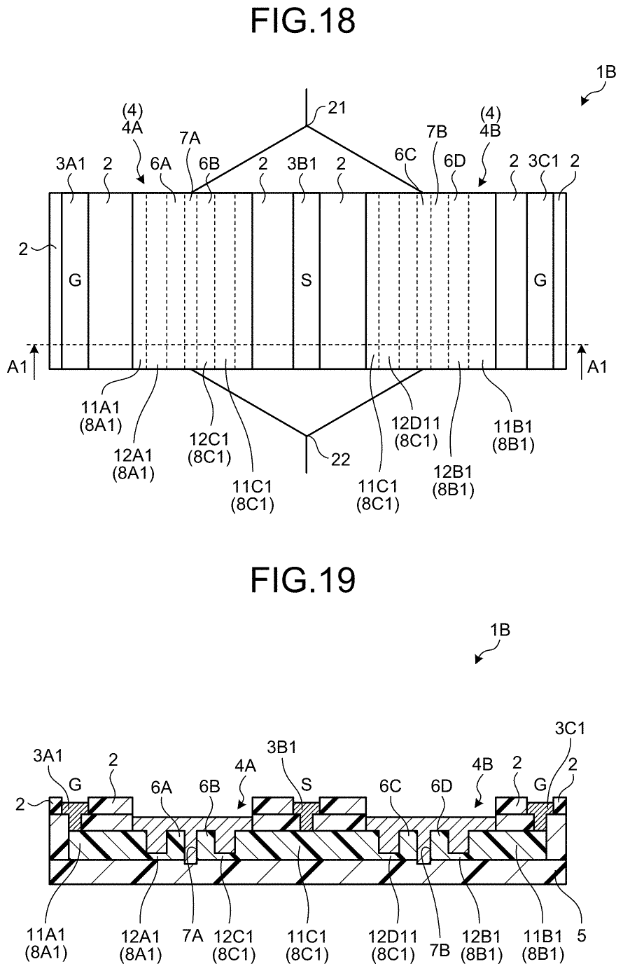

FIG. 18 is a plan view illustrating an example of an optical modulator (a GSG type) 1B in a third embodiment. FIG. 19 is an A1-A1 line sectional view of FIG. 18. The optical modulator 1B illustrated in FIG. 18 is a Mach-Zehnder modulator of a GSG type. The optical modulator 1B includes an optical dividing portion 21, two optical waveguides 4, and an optical multiplexing portion 22. The optical dividing portion 21 optically divides an optical signal and outputs the optical signal after the optical division to the optical waveguides 4. The two optical waveguides 4 include, for example, a first optical waveguide 4A and a second optical waveguide 4B. The first optical waveguide 4A phase-modulates the optical signal received from the optical dividing portion 21 and outputs the optical signal after the phase modulation to the optical multiplexing portion 22. The second optical waveguide 4B phase-modulates the optical signal received from the optical dividing portion 21 and outputs the optical signal after the phase modulation to the optical multiplexing portion 22. The optical multiplexing portion 22 multiplexes the optical signal after the phase modulation from the optical waveguides 4 and outputs the optical signal after the multiplexing.

The optical modulator 1B includes, besides the first optical waveguide 4A and the second optical waveguide 4B, the first protective film 2, a first electrode 3A1 (G), a second electrode 3B1 (S), and a third electrode 3C1 (G). The first electrode 3A1 is, for example, a negative electrode. The second electrode 3B1 is a positive electrode that applies a driving voltage to the first optical waveguide 4A and the second optical waveguide 4B. The third electrode 3C1 is, for example, a negative electrode.

Further, the optical modulator 1B includes a first slab 8A1, the first optical waveguide 4A, a third slab 8C1, the second optical waveguide 4B, and a second slab 8B1. The first optical waveguide 4A is formed by filling the EO polymer 41 in a first slot portion 7A formed between the first rail 6A disposed on the substrate 5 and the second rail 6B disposed on the substrate 5 in parallel to the first rail 6A. The second optical waveguide 4B is formed by filling the EO polymer 41 in a second slot portion 7B formed between a third rail 6C disposed on the substrate 5 and a fourth rail 6D disposed on the substrate 5 in parallel to the third rail 6C.

The first slab 8A1 is disposed on the substrate 5 and electrically connects the first rail 6A and the first electrode 3A1. The second slab 8B1 is disposed on the substrate and electrically connects the fourth rail 6D and the third electrode 3C1. The third slab 8C1 is disposed on the substrate 5 and electrically connects the second rail 6B and the second electrode 3B1 and electrically connects the third rail 6C and the second electrode 3B1.

The first slab 8A1 includes the first partial slab 11A1 and a second partial slab 12A1. The first partial slab 11A1 is electrically connected to the first electrode 3A1. The second partial slab 12A1 electrically connects the first rail 6A and the first partial slab 11A1. In the first slab 8A1, the thickness dimension Hs2 of the second partial slab 12A1 is set small compared with the thickness dimension Hr of the first rail 6A with respect to the surface of the substrate 5. Note that it is desirable to set the thickness dimension Hr of the first rail 6A to a triple or more of the thickness dimension Hs2 of the second partial slab 12A1.

The second slab 8B1 includes the third partial slab 11B1 and a fourth partial slab 12B1. The third partial slab 11B1 is electrically connected to the third electrode 3C1. The fourth partial slab 12B1 electrically connects the fourth rail 6D and the third partial slab 11B1. In the second slab 8B1, the thickness dimension Hs2 of the fourth partial slab 12B1 is set small compared with the thickness dimension Hr of the fourth rail 6D with respect to the surface of the substrate 5. Note that it is desirable to set the thickness dimension Hr of the fourth rail 6D to a triple or more of the thickness dimension Hs2 of the fourth partial slab 12B1.

The third slab 8C1 includes a fifth partial slab 11C1, a sixth partial slab 12C1, and a seventh partial slab 12D11. The fifth partial slab 11C1 is electrically connected to the second electrode 3B1. The sixth partial slab 12C1 electrically connects the second rail 6B and the fifth partial slab 11C1. The seventh partial slab 12D11 electrically connects the third rail 6C and the fifth partial slab 11C1.

In the third slab 8C1, the thickness dimension Hs2 of the sixth partial slab 12C1 is set small compared with the thickness dimension Hr of the second rail 6B with respect to the surface of the substrate 5. Note that it is desirable to set the thickness dimension Hr of the second rail 6B to a triple or more of the thickness dimension Hs2 of the sixth partial slab 12C1. In the third slab 8C1, the thickness dimension Hs2 of the seventh partial slab 12D11 is set small compared with the thickness dimension Hr of the third rail 6C with respect to the surface of the substrate 5. Note that it is desirable to set the thickness dimension Hr of the third rail 6C to a triple or more of the thickness dimension Hs2 of the seventh partial slab 12D11.

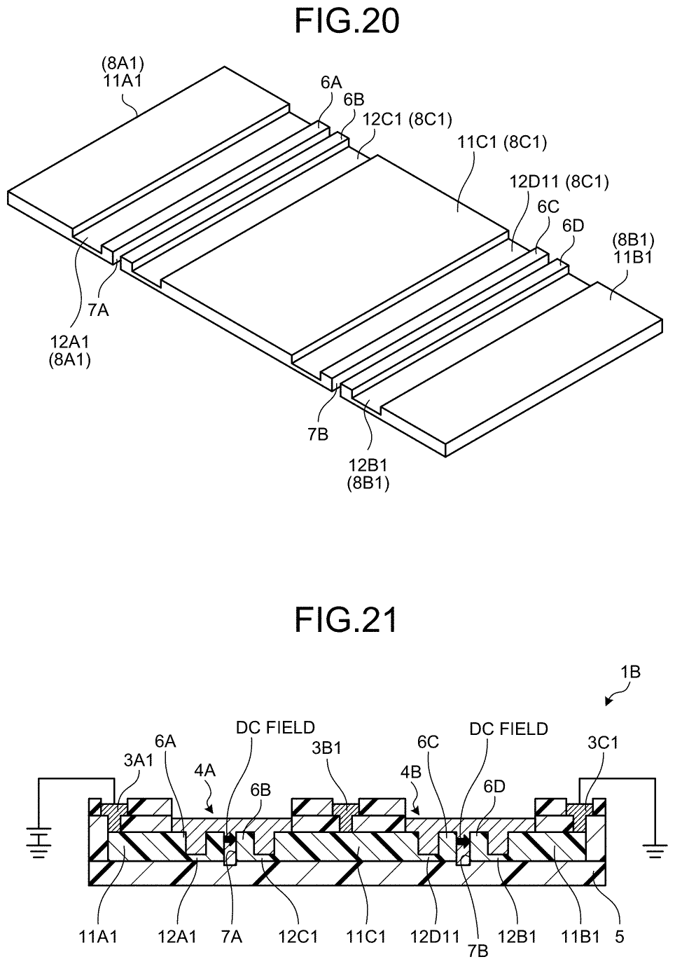

FIG. 20 is a perspective view of a slab in the third embodiment. The slab illustrated in FIG. 20 includes the first slab 8A1, the first rail 6A, the first slot portion 7A, the second rail 6B, the third slab 8C1, the third rail 6C, the second slot portion 7B, the fourth rail 6D, and the second slab 8B1. Note that the second rail 6B and the third rail 6C are electrically coupled by the third slab 8C1.

Manufacturing Process for Optical Modulator 1B in Third Embodiment

FIG. 21 is an explanatory diagram illustrating an example of an action during polling of the optical modulator 1B of the GSG type. The EO polymer 41 in the first optical waveguide 4A and the second optical waveguide 4B in the optical modulator 1B is heated to near the glass transition temperature to allow dye molecules in the EO polymer 41 to easily move. Then, a DC voltage is applied to the first electrode 3A1. As a result, the DC voltage is applied to the first electrode 3A1 and an electric current flows from the first electrode 3A1 to the third electrode 3C1. Therefore, the dye molecules of the EO polymer 41 in the first optical waveguide 4A and the second optical waveguide 4B are orientated in one direction. Thereafter, the temperature of the EO polymer 41 in the first optical waveguide 4A and the second optical waveguide 4B is lowered to fix a state of the orientation of the EO polymer 41. Note that the second electrode 3B1 (the positive electrode) is not used during polling.

Note that a DC voltage may be applied to the third electrode 3C1 to feed an electric current from the third electrode 3C1 to the first electrode 3A1. The orientation of dye molecules of the EO polymer 41 in the first optical waveguide 4A and the second optical waveguide 4B may be directed in a fixed direction and can be changed as appropriate.

Operation Action of Optical Modulator 1B in Third Embodiment

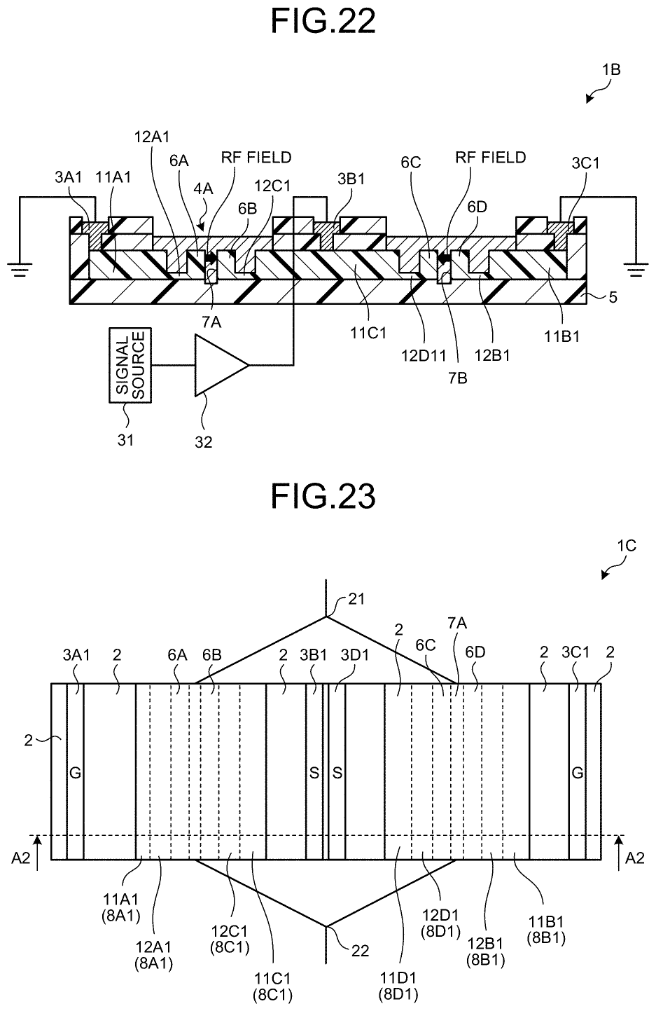

FIG. 22 is an explanatory diagram illustrating an example of an action during operation of the optical modulator 1B of the GSG type. The optical modulator 1B of the GSG type includes the signal source 31 that generates an electric signal and the driver 32 that outputs the electric signal received from the signal source 31. The driver 32 is connected to the second electrode 3B1 of the optical modulator 1B and connects the first electrode 3A1 and the third electrode 3C1 to the earth. The driver 32 applies a driving voltage to the first optical waveguide 4A and the second optical waveguide 4B in the optical modulator 1B. An electric current flows from the second electrode 3B1 to the first electrode 3A1 and the third electrode 3C1. As a result, an optical signal passing through the first optical waveguide 4A and the second optical waveguide 4B is phase-modulated.

Effects in Third Embodiment

The optical modulator 1B of the GSG type applies the driving voltage received from the second electrode 3B1 to the first optical waveguide 4A and the second optical waveguide 4B to phase-modulate the optical signal passing through the first optical waveguide 4A and the second optical waveguide 4B. Note that a modulating action of the optical modulator 1B of the GSG type is a push-pull action performed using two optical waveguides 4. Therefore, the half wavelength voltage Vπ can be halved.

### [d] Fourth Embodiment

Configuration of Optical Modulator 1C in Fourth Embodiment

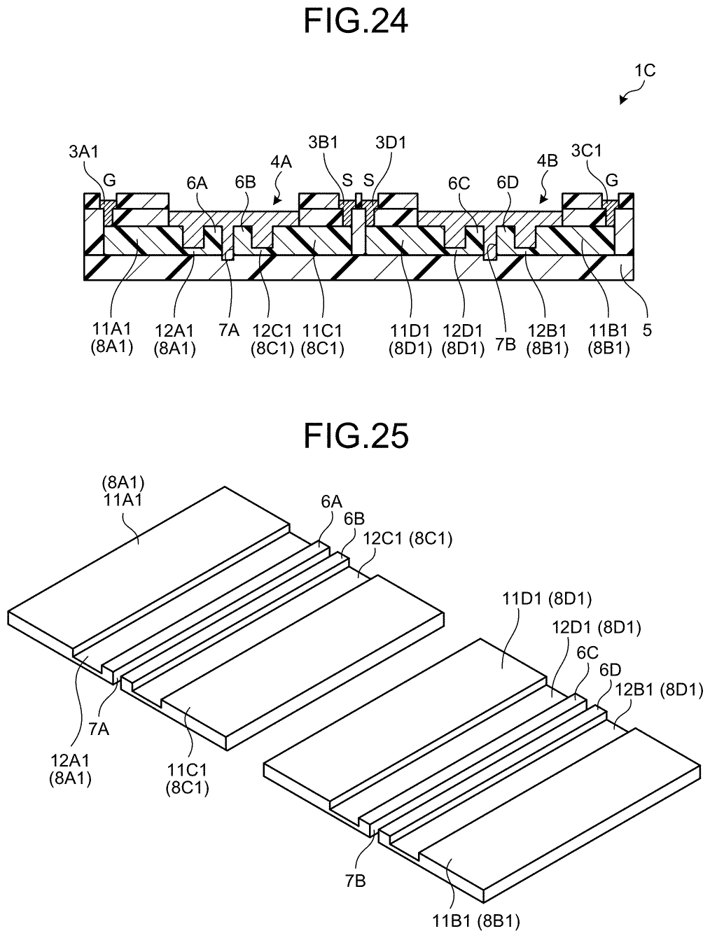

FIG. 23 is a plan view illustrating an example of an optical modulator (a GSSG type) 1C in a fourth embodiment. FIG. 24 is an A2-A2 line sectional view of FIG. 23. The optical modulator 1C illustrated in FIG. 23 is a Mach-Zehnder modulator of the GSSG type. The optical modulator 1C includes the optical dividing portion 21, two optical waveguides 4, and the optical multiplexing portion 22. The optical dividing portion 21 optically divides an optical signal and outputs the optical signal after the optical division to the optical waveguides 4. The two optical waveguides 4 include, for example, a first optical waveguide 4A and a second optical waveguide 4B. The first optical waveguide 4A phase-modulates the optical signal received from the optical dividing portion 21 and outputs the optical signal after the phase modulation to the optical multiplexing portion 22. The second optical waveguide 4B phase-modulates the optical signal received from the optical dividing portion 21 and outputs the optical signal after the phase modulation to the optical multiplexing portion 22. The optical multiplexing portion 22 multiplexes the optical signal after the phase modulation from the optical waveguides 4 and outputs the optical signal after the multiplexing.

The optical modulator 1C includes, besides the first optical waveguide 4A and the second optical waveguide 4B, the first protective film 2, the first electrode 3A1 (G), the second electrode 3B1 (S), a fourth electrode 3D1 (S), and the third electrode 3C1 (G). The first electrode 3A1 is, for example, a negative electrode. The second electrode 3B1 is, for example, a positive electrode that applies a driving voltage. The fourth electrode 3D1 is, for example, a positive electrode that applies a driving voltage. The third electrode 3C1 is, for example, a negative electrode.

Further, the optical modulator 1C includes the first slab 8A1, the first optical waveguide 4A, the third slab 8C1, a fourth slab 8D1, the second optical waveguide 4B, and the second slab 8B1. The first optical waveguide 4A is formed by filling the EO polymer 41 in the first slot portion 7A formed between the first rail 6A disposed on the substrate 5 and the second rail 6B disposed on the substrate 5 in parallel to the first rail 6A. The second optical waveguide 4B is formed by filling the EO polymer 41 in the second slot portion 7B formed between the third rail 6C disposed on the substrate 5 and the fourth rail 6D disposed on the substrate 5 in parallel to the third rail 6C.

The first slab 8A1 is disposed on the substrate 5 and electrically connects the first rail 6A and the first electrode 3A1. The third slab 8C1 is disposed on the substrate 5 and electrically connects the second rail 6B and the second electrode 3B1.

The first slab 8A1 includes the first partial slab 11A1 and the second partial slab 12A1. The first partial slab 11A1 is electrically connected to the first electrode 3A1. The second partial slab 12A1 electrically connects the first rail 6A and the first partial slab 11A1. In the first slab 8A1, the thickness dimension Hs2 of the second partial slab 12A1 is set small compared with the thickness dimension Hr of the first rail 6A with respect to the surface of the substrate 5. Note that it is desirable to set the thickness dimension Hr of the first rail 6A to a triple or more of the thickness dimension Hs2 of the second partial slab 12A1.

The second slab 8B1 is disposed on the substrate 5 and electrically connects the fourth rail 6D and the third electrode 3C1. The second slab 8B1 includes the third partial slab 11B1 and the fourth partial slab 12B1. The third partial slab 11B1 is electrically connected to the third electrode 3C1. The fourth partial slab 12B1 electrically connects the fourth rail 6D and the third partial slab 11B1. In the second slab 8B1, the thickness dimension Hs2 of the fourth partial slab 12B1 is set small compared with the thickness dimension Hr of the fourth rail 6D with respect to the surface of the substrate 5. Note that it is desirable to set the thickness dimension Hr of the fourth rail 6D to a triple or more of the thickness dimension Hs2 of the fourth partial slab 12B1.

The third slab 8C1 includes the fifth partial slab 11C1 and the sixth partial slab 12C1. The fifth partial slab 11C1 is electrically connected to the second electrode 3B1. The sixth partial slab 12C1 electrically connects the second rail 6B and the fifth partial slab 11C1. In the third slab 8C1, the thickness dimension Hs2 of the sixth partial slab 12C1 is set small compared with the thickness dimension Hr of the second rail 6B with respect to the surface of the substrate 5. Note that it is desirable to set the thickness dimension Hr of the second rail 6B to a triple or more of the thickness dimension Hs2 of the sixth partial slab 12C1.

The fourth slab 8D1 is disposed on the substrate 5 and electrically connects the third rail 6C and the fourth electrode 3D1. The fourth slab 8D1 includes a seventh partial slab 11D1 and an eighth partial slab 12D1. The seventh partial slab 11D1 is electrically connected to the fourth electrode 3D1. The eighth partial slab 12D1 electrically connects the third rail 6C and the seventh partial slab 11D1. In the fourth slab 8D1, the thickness dimension Hs2 of the eighth partial slab 12D1 is set small compared with the thickness dimension Hr of the third rail 6C with respect to the surface of the substrate 5. Note that it is desirable to set the thickness dimension Hr of the third rail 6C to a triple or more of the thickness dimension Hs2 of the eighth partial slab 12D1.

FIG. 25 is a perspective view of a slab in the fourth embodiment. The slab illustrated in FIG. 25 includes the first slab 8A1, the first rail 6A, the first slot portion 7A, the second rail 6B, the third slab 8C1, and the fourth slab 8D1. Further, the slab includes the third rail 6C, the second slot portion 7B, the fourth rail 6D, and the second slab 8B1. Note that the third slab 8C1 and the fourth slab 8D1 are electrically separated.

Manufacturing Process for Optical Modulator 1C in Fourth Embodiment

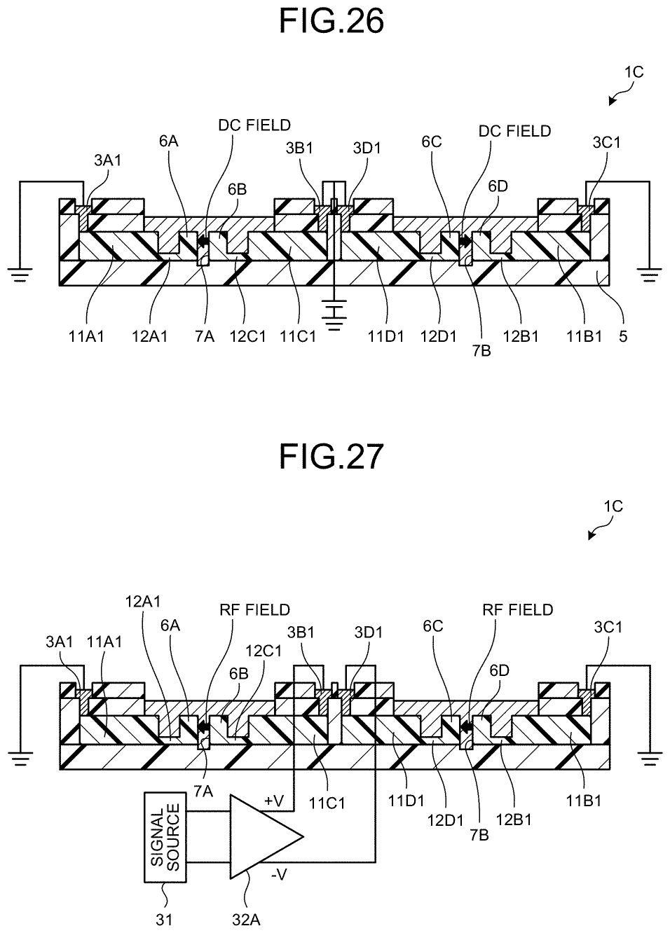

FIG. 26 is an explanatory diagram illustrating an example of an action during polling of the optical modulator 1C of the GSSG type. The EO polymer 41 in the first optical waveguide 4A and the second optical waveguide 4B in the optical modulator 1C is heated to near the glass transition temperature to allow dye molecules in the EO polymer 41 to easily move. Then, a DC voltage is applied to the second electrode 3B1 and the fourth electrode 3D1. As a result, the DC voltage is applied to the second electrode 3B1 and an electric current flows from the second electrode 3B1 to the first electrode 3A1. Therefore, the dye molecules of the EO polymer 41 in the first optical waveguide 4A are oriented in one direction. The DC voltage is applied to the fourth electrode 3D1 and an electric current flows from the fourth electrode 3D1 to the second electrode 3B1. Therefore, the dye molecules of the EO polymer 41 in the second optical waveguide 4B are oriented in one direction. Thereafter, the temperature of the EO polymer 41 in the first optical waveguide 4A and the second optical waveguide 4B is lowered to fix a state of the orientation of the EO polymer 41.

Operation Action of Optical Modulator 1C in Fourth Embodiment

FIG. 27 is an explanatory diagram illustrating an example of an action during operation of the optical modulator 1C of the GSSG type. The optical modulator 1C of the GSSG type includes the signal source 31 that generates an electric signal and a differential driver 32A that outputs the electric signal received from the signal source 31. The differential driver 32A is connected to the second electrode 3B1 and the fourth electrode 3D1 of the optical modulator 1C. The first electrode 3A1 and the third electrode 3C1 are connected to the earth. The differential driver 32A applies a driving voltage to the first optical waveguide 4A in the optical modulator 1C and, when an electric current flows from the second electrode 3B1 to the first electrode 3A1, phase-modulates an optical signal passing through the first optical waveguide 4A. The differential driver 32A applies a driving voltage to the second optical waveguide 4B and, when an electric current flows from the fourth electrode 3D1 to the third electrode 3C1, phase-modulates an optical signal passing through the second optical waveguide 4B.

Effects in Fourth Embodiment

The optical modulator 1C of the GSSG type applies the driving voltages received from the second electrode 3B1 and the fourth electrode 3D1 to the first optical waveguide 4A and the second optical waveguide 4B to phase-modulate the optical signal passing through the first optical waveguide 4A and the second optical waveguide 4B. Note that a modulating action of the optical modulator 1C of the GSSG type is also the push-pull action performed using the two optical waveguides 4. Therefore, the half wavelength voltage Vπ can be halved.

### [e] Fifth Embodiment

Configuration of Optical Modulator 1D in Fifth Embodiment

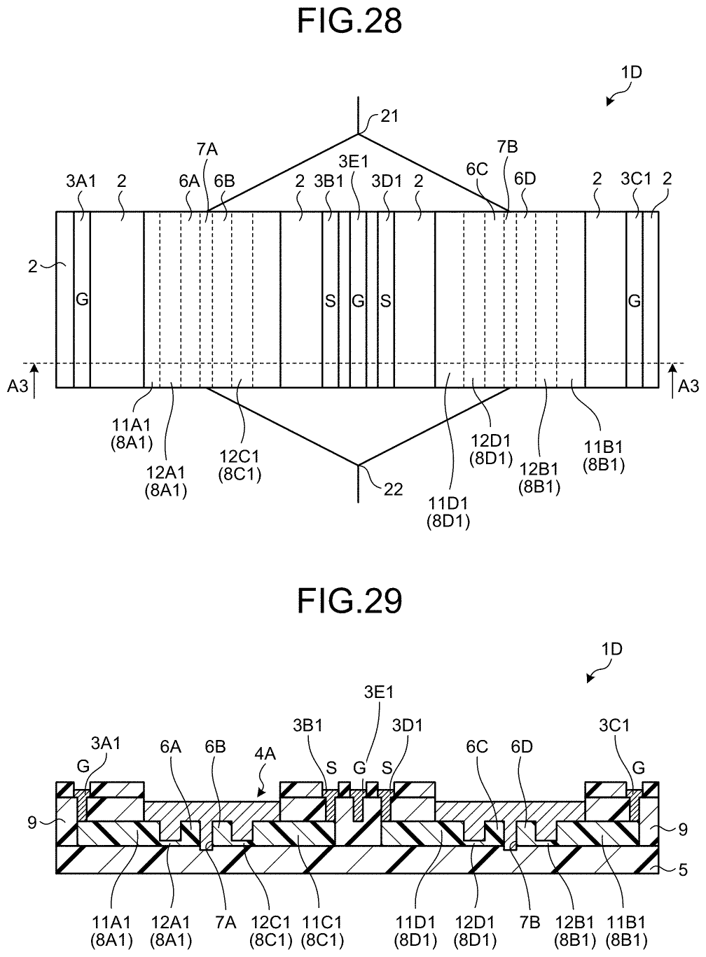

FIG. 28 is a plan view illustrating an example of an optical modulator (a GSGSG type) 1D in a fifth embodiment. FIG. 29 is an A3-A3 line sectional view of FIG. 28. The optical modulator 1D illustrated in FIG. 28 is a Mach-Zehnder modulator of the GSGSG type. The optical modulator 1D includes the optical dividing portion 21, two optical waveguides 4, and the optical multiplexing portion 22. The optical dividing portion 21 optically divides an optical signal and outputs the optical signal after the optical division to the optical waveguides 4. The two optical waveguides 4 include, for example, a first optical waveguide 4A and a second optical waveguide 4B. The first optical waveguide 4A phase-modulates the optical signal received from the optical dividing portion 21 and outputs the optical signal after the phase modulation to the optical multiplexing portion 22. The second optical waveguide 4B phase-modulates the optical signal received from the optical dividing portion 21 and outputs the optical signal after the phase modulation to the optical multiplexing portion 22. The optical multiplexing portion 22 multiplexes the optical signal after the phase modulation from the optical waveguides 4 and outputs the optical signal after the multiplexing.

The optical modulator 1D includes, besides the first optical waveguide 4A and the second optical waveguide 4B, the first protective film 2, the first electrode 3A1 (G), the second electrode 3B1 (S), a fifth electrode 3E1 (G), the fourth electrode 3D1 (S), and the third electrode 3C1 (G). The first electrode 3A1 is, for example, a negative electrode. The second electrode 3B1 is, for example, a positive electrode. The fifth electrode 3E1 is, for example, a negative electrode. The fourth electrode 3D1 is, for example, a positive electrode. The third electrode 3C1 is, for example, a negative electrode.

Further, the optical modulator 1D includes the first slab 8A1, the first optical waveguide 4A, the third slab 8C1, the fourth slab 8D1, the second optical waveguide 4B, and the second slab 8B1. The first optical waveguide 4A is formed by filling the EO polymer 41 in a first slot portion 7A formed between the first rail 6A disposed on the substrate 5 and the second rail 6B disposed on the substrate 5 in parallel to the first rail 6A. The second optical waveguide 4B is formed by filling the EO polymer 41 in a second slot portion 7B formed between a third rail 6C disposed on the substrate 5 and a fourth rail 6D disposed on the substrate 5 in parallel to the third rail 6C.

The first slab 8A1 is disposed on the substrate 5 and electrically connects the first rail 6A and the first electrode 3A1. The third slab 8C1 is disposed on the substrate 5 and electrically connects the second rail 6B and the second electrode 3B1.

The first slab 8A1 includes the first partial slab 11A1 and a second partial slab 12A1. The first partial slab 11A1 is electrically connected to the first electrode 3A1. The second partial slab 12A1 electrically connects the first rail 6A and the first partial slab 11A1. In the first slab 8A1, the thickness dimension Hs2 of the second partial slab 12A1 is set small compared with the thickness dimension Hr of the first rail 6A with respect to the surface of the substrate 5. Note that it is desirable to set the thickness dimension Hr of the first rail 6A to a triple or more of the thickness dimension Hs2 of the second partial slab 12A1.

The second slab 8B1 is disposed on the substrate 5 and electrically connects the fourth rail 6D and the third electrode 3C1. The second slab 8B1 includes the third partial slab 11B1 and the fourth partial slab 12B1. The third partial slab 11B1 is electrically connected to the third electrode 3C1. The fourth partial slab 12B1 electrically connects the fourth rail 6D and the third partial slab 11B1. In the second slab 8B1, the thickness dimension Hs2 of the fourth partial slab 12B1 is set small compared with the thickness dimension Hr of the fourth rail 6D with respect to the surface of the substrate 5. Note that it is desirable to set the thickness dimension Hr of the fourth rail 6D to a triple or more of the thickness dimension Hs2 of the fourth partial slab 12B1.

The third slab 8C1 includes the fifth partial slab 11C1 and the sixth partial slab 12C1. The fifth partial slab 11C1 is electrically connected to the second electrode 3B1. The sixth partial slab 12C1 electrically connects the second rail 6B and the fifth partial slab 11C1. In the third slab 8C1, the thickness dimension Hs2 of the sixth partial slab 12C1 is set small compared with the thickness dimension Hr of the second rail 6B with respect to the surface of the substrate 5. Note that it is desirable to set the thickness dimension Hr of the second rail 6B to a triple or more of the thickness dimension Hs2 of the sixth partial slab 12C1.

The fourth slab 8D1 is disposed on the substrate 5 and electrically connects the third rail 6C and the fourth electrode 3D1. The fourth slab 8D1 includes the seventh partial slab 11D1 and the eighth partial slab 12D1. The seventh partial slab 11D1 is electrically connected to the fourth electrode 3D1. The eighth partial slab 12D1 electrically connects the third rail 6C and the seventh partial slab 11D1. In the fourth slab 8D1, the thickness dimension Hs2 of the eighth partial slab 12D1 is set small compared with the thickness dimension Hr of the third rail 6C with respect to the surface of the substrate 5. Note that it is desirable to set the thickness dimension Hr of the third rail 6C to a triple or more of the thickness dimension Hs2 of the eighth partial slab 12D1.

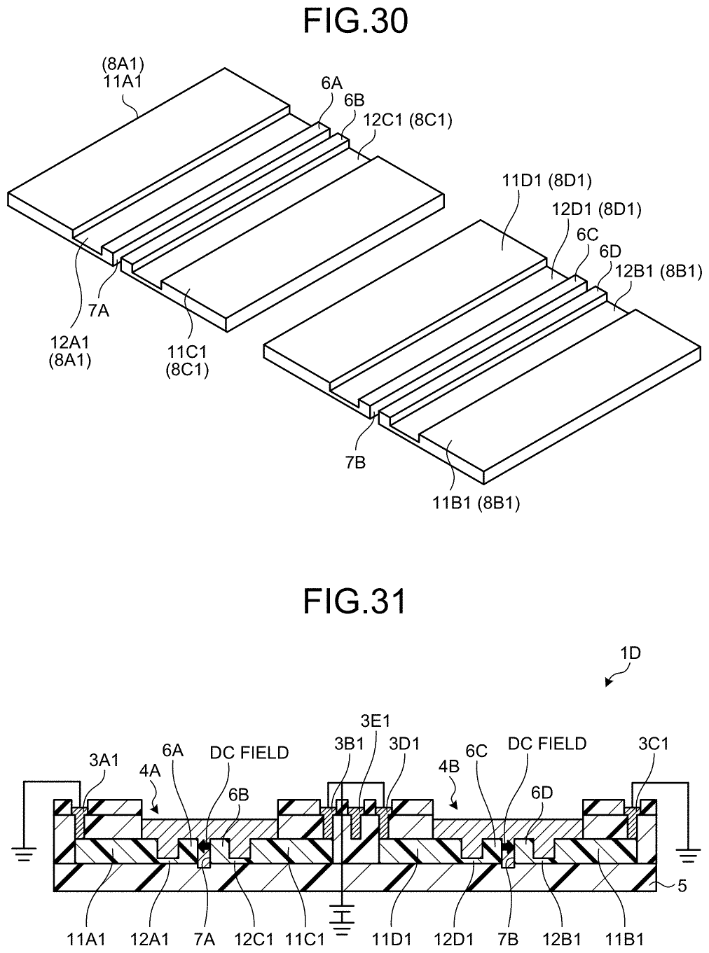

FIG. 30 is a perspective view of a slab in the fifth embodiment. The slab illustrated in FIG. 30 includes the first slab 8A1, the first rail 6A, the first slot portion 7A, the second rail 6B, and the third slab 8C1. Further, the slab includes the fourth slab 8D1, the third rail 6C, the second slot portion 7B, the fourth rail 6D, and the second slab 8B1. Note that the third slab 8C1 and the fourth slab 8D1 are electrically separated.

Manufacturing Step for Optical Modulator 1D in Fifth Embodiment

FIG. 31 is an explanatory diagram illustrating an example of an action during polling of the optical modulator 1D of the GSGSG type, The EO polymer 41 in the first optical waveguide 4A and the second optical waveguide 4B in the optical modulator 1D is heated to near the glass transition temperature to allow dye molecules in the EO polymer 41 to easily move. Then, a DC voltage is applied to the second electrode 3B1 and the fourth electrode 3D1. As a result, the DC voltage is applied to the second electrode 3B1 and an electric current flows from the second electrode 3B1 to the first electrode 3A1. Therefore, the dye molecules of the EO polymer 41 in the first optical waveguide 4A are oriented in one direction. The DC voltage is applied to the fourth electrode 3D1 and an electric current flows from the fourth electrode 3D1 to the third electrode 3C1. Therefore, the dye molecules of the EO polymer 41 in the second optical waveguide 4B are oriented in one direction. Thereafter, the temperature of the EO polymer 41 in the first optical waveguide 4A and the second optical waveguide 4B is lowered to fix a state of the orientation of the EO polymer 41.

Operation Action of Optical Modulator 1D in Fifth Embodiment

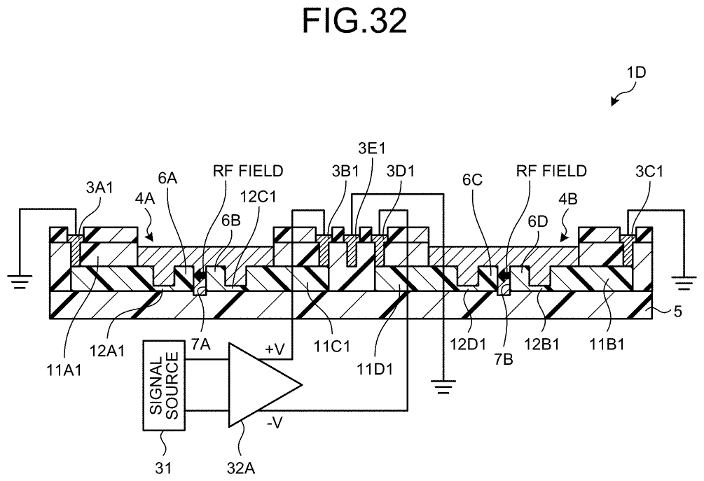

FIG. 32 is an explanatory diagram illustrating an example of an action during operation of the optical modulator 1D of the GSGSG type. The optical modulator 1D of the GSGSG type includes the signal source 31 that generates an electric signal and the differential driver 32A that outputs the electric signal received from the signal source 31. The differential driver 32A is connected to the second electrode 3B1 and the fourth electrode 3D1 of the optical modulator 1D. The first electrode 3A1, the third electrode 3C1, and the fifth electrode 3E1 are connected to the earth. The differential driver 32A applies a driving voltage to the second electrode 3B1 and, when an electric current flows from the second electrode 3B1 to the first electrode 3A1, phase-modulates an optical signal passing through the first optical waveguide 4A. The differential driver 32A applies a driving voltage to the fourth electrode 3D1 and, when an electric current flows from the fourth electrode 3D1 to the third electrode 3C1, phase-modulates an optical signal passing through the second optical waveguide 4B.

Effects in Fifth Embodiment

The optical modulator 1D of the GSGSG type applies the driving voltage to the second electrode 3B1 and the fourth electrode 3D1 to phase-modulate, with an electric signal corresponding to the driving voltage, the optical signal passing through the first optical waveguide 4A and the second optical waveguide 4B. Note that a modulating action of the optical modulator 1D of the GSGSG type is also a push-pull action performed using two optical waveguides 4. Therefore, the half wavelength voltage Vπ can be halved.

Note that, for convenience of explanation, the polymer is illustrated as the electro-optic material forming the optical waveguide 4. However, the electro-optic material is not limited to the polymer and can be changed as appropriate if the electro-optic material is an electro-optic material that can be filled in the slot.

The components of the illustrated sections do not always need to be physically configured as illustrated. That is, specific forms of distribution and integration of the sections is not limited to the illustrated form. All or a part of the sections can be configured by functionally or physically distributing and integrating the sections in any unit according to various loads, states of use, and the like.

It is possible to suppress the driving voltage and the optical loss.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An optical modulator comprising:
a slot portion formed between a first rail disposed on a substrate and a second rail disposed on the substrate in parallel to the first rail;
an optical waveguide formed by filling an electro-optic material in the slot portion;
a first slab that electrically connects the first rail and a first electrode and is disposed on the substrate; and
a second slab that electrically connects the second rail and a second electrode and is disposed on the substrate, wherein
the first slab includes a first partial slab electrically connected to the first electrode and a second partial slab electrically connecting the first rail and the first partial slab, and a thickness dimension of the second partial slab with respect to a surface of the substrate is set small compared with the thickness dimension of the first rail, and
the second slab includes a third partial slab electrically connected to the second electrode and a fourth partial slab electrically connecting the second rail and the third partial slab, and a thickness dimension of the fourth partial slab with respect to the surface of the substrate is set small compared with the thickness dimension of the second rail.

2. The optical modulator according to claim 1, wherein
the thickness dimension of the first rail with respect to the surface of the substrate is set to a triple or more of the thickness dimension of the second partial slab with respect to the surface of the substrate, and
the thickness dimension of the second rail with respect to the surface of the substrate is set to a triple or more of the thickness dimension of the fourth partial slab with respect to the surface of the substrate.

3. The optical modulator according to claim 1, wherein the optical waveguide is formed by filling a polymer material in the slot portion as the electro-optic material.

4. The optical modulator according to claim 1, wherein a recess is formed on the surface of the substrate and the slot portion is formed on the recess.

5. The optical modulator according to claim 1, wherein
doping concentration of silicon forming a material of the first partial slab is set high compared with the doping concentration of the silicon before forming a material of the first rail and the second partial slab, and
the doping concentration of the silicon forming a material of the third partial slab is set high compared with the doping concentration of the silicon forming a material of the second rail and the fourth partial slab.

6. An optical modulator comprising:
a first slot portion formed between a first rail disposed on a substrate and a second rail disposed on the substrate in parallel to the first rail;
a first optical waveguide formed by filling an electro-optic material in the first slot portion;
a second slot portion formed between a third rail disposed on the substrate and a fourth rail disposed on the substrate in parallel to the third rail;
a second optical waveguide formed by filling the electro-optic material in the second slot portion;
a first slab that electrically connects the first rail and a first negative electrode and is disposed on the substrate;
a second slab that electrically connects the fourth rail and a second negative electrode and is disposed on the substrate; and
a third slab that electrically connects the second rail and a positive electrode, electrically connects the third rail and the positive electrode, and is disposed on the substrate, wherein
the first slab includes a first partial slab electrically connected to the first negative electrode and a second partial slab that electrically connects the first rail and the first partial slab, and a thickness dimension of the second partial slab with respect to a surface of the substrate is set small compared with the thickness dimension of the first rail,
the second slab includes a third partial slab electrically connected to the second negative electrode and a fourth partial slab that electrically connects the fourth rail and the third partial slab, and a thickness dimension of the fourth partial slab with respect to the surface of the substrate is set small compared with the thickness dimension of the fourth rail, and
the third slab includes a fifth partial slab electrically connected to the positive electrode, a sixth partial slab that electrically connects the second rail and the fifth partial slab, and a seventh partial slab that electrically connects the third rail and the fifth partial slab, and a thickness dimension of the sixth partial slab with respect to the surface of the substrate is set small compared with the thickness dimension of the second rail and the thickness dimension of the seventh partial slab with respect to the surface of the substrate is set small compared with the thickness dimension of the third rail.

7. An optical modulator comprising:
a first slot portion formed between a first rail disposed on a substrate and a second rail disposed on the substrate in parallel to the first rail;
a first optical waveguide formed by filling an electro-optic material in the first slot portion;
a second slot portion formed between a third rail disposed on the substrate and a fourth rail disposed on the substrate in parallel to the third rail;
a second optical waveguide formed by filling the electro-optic material in the second slot portion;
a first slab that electrically connects the first rail and a first negative electrode and is disposed on the substrate;
a second slab that electrically connects the fourth rail and a second negative electrode and is disposed on the substrate;
a third slab that electrically connects the second rail and a first positive electrode and is disposed on the substrate; and
a fourth slab that electrically connects the third rail and a second positive electrode and is disposed on the substrate, wherein
the first slab includes a first partial slab electrically connected to the first negative electrode and a second partial slab that electrically connects the first rail and the first partial slab, and a thickness dimension of the second partial slab with respect to a surface of the substrate is set small compared with the thickness dimension of the first rail,
the second slab includes a third partial slab electrically connected to the second negative electrode and a fourth partial slab that electrically connects the fourth rail and the third partial slab, and a thickness dimension of the fourth partial slab with respect to the surface of the substrate is set small compared with the thickness dimension of the fourth rail,
the third slab includes a fifth partial slab electrically connected to the first positive electrode and a sixth partial slab that electrically connects the second rail and the fifth partial slab, and a thickness dimension of the sixth partial slab with respect to the surface of the substrate is set small compared with the thickness dimension of the second rail, and
the fourth slab includes a seventh partial slab electrically connected to the second positive electrode and an eighth partial slab that electrically connects the third rail and the seventh partial slab, and a thickness dimension of the eighth partial slab with respect to the surface of the substrate is set small compared with the thickness dimension of the third rail.

8. The optical modulator according to claim 7, wherein the optical modulator includes a third negative electrode between the first positive electrode and the second positive electrode.
